(19) United States
(12) Patent Application Publication
(10) Pub. No.: US 2015/0281979 A1
(43) Pub. Date: Oct. 1, 2015

(54) APPARATUS, SYSTEM AND METHOD OF COMMUNICATING ORIENTATION INFORMATION BETWEEN WIRELESS COMMUNICATION DEVICES

(71) Applicant: Assaf Kasher, Haifa (IL)

(72) Inventor: Assaf Kasher, Haifa (IL)

(21) Appl. No.: 14/226,474

(22) Filed: Mar. 26, 2014

(51) Int. Cl. H04W 24/02; H04W 24/08; H04W 4/02

(52) U.S. Cl. CPC H04W 24/02; H04W 4/026; H04W 24/08

(57) ABSTRACT

Some demonstrative embodiments include devices, systems and/or methods of communicating orientation information. For example, an apparatus may include a controller to receive at a first wireless communication device an orientation feedback from a second wireless communication device, subsequent to establishment of a directional wireless communication link with the second wireless communication device, the orientation feedback including an indication of an estimated orientation of the second wireless communication device, wherein, based on the estimated orientation of the second wireless communication device, the controller is to instruct the first wireless communication device to output a recommendation to change an orientation of the second wireless communication device.

### TECHNICAL FIELD

Embodiments described herein generally relate to communicating orientation information between wireless communication devices.

### BACKGROUND

Wireless devices are becoming more and more common in everyday life.

A first wireless communication device and a second wireless communication device may establish a wireless communication link between the first and the second wireless communication devices, to enable exchanging data between the first and second wireless communication devices.

The wireless communication link may include a directional wireless communication link.

A quality of the directional wireless communication link may be reduced as a result of a change in an orientation of the first and/or the second wireless communication devices.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative embodiments.

FIG. 2 is a schematic deployment of a system, in accordance with some demonstrative embodiments.

FIG. 3 is a schematic flow chart illustration of a method of advising a user of a mobile device to change an orientation of the mobile device, in accordance with some demonstrative embodiments.

FIG. 4 is a schematic deployment of a system, in accordance with some demonstrative embodiments.

FIG. 5 is a schematic flow chart illustration of a method of advising a user of a mobile device to change an orientation of the mobile device, in accordance with some demonstrative embodiments.

FIG. 6 is a schematic flow chart illustration of a method of communicating orientation information between wireless communication devices, in accordance with some demonstrative embodiments.

FIG. 7 is a schematic illustration of a product of manufacture, in accordance with some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some embodiments may be used in conjunction with various devices and systems, for example, a Personal Computer (PC), a desktop computer, a mobile computer, a laptop computer, a notebook computer, a tablet computer, an Ultrabook™ computer, a server computer, a handheld computer, a handheld device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (AN) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some embodiments may be used in conjunction with devices and/or networks operating in accordance with existing Wireless-Gigabit-Alliance (WGA) specifications (Wireless Gigabit Alliance, Inc WiGig MAC and PHY Specification Version 1.1, April 2011, Final specification) and/or future versions and/or derivatives thereof, devices and/or networks operating in accordance with existing IEEE 802.11 standards (IEEE 802.11-2012, IEEE Standard for Information technology—Telecommunications and information exchange between systems Local and metropolitan area networks—Specific requirements Part 11: Wireless LAN Medium Access Control (MAC) and Physical Layer (PHY) Specifications, Mar. 29, 2012; IEEE802.11 task group ac (TGac) (“IEEE802.11-09/0308r12—TGac Channel Model Addendum Document”); IEEE 802.11 task group ad (TGad) (IEEE P802.11ad-2012, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications—Amendment 3: Enhancements for Very High Throughput in the 60 GHz Band, 28 Dec. 2012)) and/or future versions and/or derivatives thereof, devices and/or networks operating in accordance with existing and/or Wireless Fidelity (WiFi) Alliance (WFA) Peer-to-Peer (P2P) specifications (WiFi P2P technical specification version 1.2, 2012) and/or future versions and/or derivatives thereof, devices and/or networks operating in accordance with existing WirelessHD™ specifications and/or future versions and/or derivatives thereof, units and/or devices which are part of the above networks, and the like.

Some embodiments may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

The term “wireless device”, as used herein, includes, for example, a device capable of wireless communication, a communication device capable of wireless communication, a communication station capable of wireless communication, a portable or non-portable device capable of wireless communication, or the like. In some demonstrative embodiments, a wireless device may be or may include a peripheral that is integrated with a computer, or a peripheral that is attached to a computer. In some demonstrative embodiments, the term “wireless device” may optionally include a wireless service.

The term “communicating” as used herein with respect to a wireless communication signal includes transmitting the wireless communication signal and/or receiving the wireless communication signal. For example, a radio, which is capable of communicating a wireless communication signal, may include a wireless transmitter to transmit the wireless communication signal to at least one other radio, and/or a wireless communication receiver to receive the wireless communication signal from at least one other radio. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device.

Some demonstrative embodiments may be used in conjunction with a WLAN. Other embodiments may be used in conjunction with any other suitable wireless communication network, for example, a wireless area network, a “piconet”, a WPAN, a WVAN and the like.

Some demonstrative embodiments may be used in conjunction with a wireless communication network communicating over a frequency band of 60 GHz. However, other embodiments may be implemented utilizing any other suitable wireless communication frequency bands, for example, an Extremely High Frequency (EHF) band (the millimeter wave (mmwave) frequency band), e.g., a frequency band within the frequency band of between 30 GHz and 300 GHZ, a WLAN frequency band, a WPAN frequency band, a frequency band according to the WGA specification, and the like.

The term “antenna”, as used herein, may include any suitable configuration, structure and/or arrangement of one or more antenna elements, components, units, assemblies and/or arrays. In some embodiments, the antenna may implement transmit and receive functionalities using separate transmit and receive antenna elements. In some embodiments, the antenna may implement transmit and receive functionalities using common and/or integrated transmit/receive elements. The antenna may include, for example, a phased array antenna, a single element antenna, a set of switched beam antennas, and/or the like.

The term “station” (STA), as used herein, may include any logical entity that is a singly addressable instance of a medium access control (MAC) and a physical layer (PHY) interface to a wireless medium (WM).

The phrase “non-access-point (non-AP) station (STA)”, as used herein, may relate to a STA that is not contained within an AP.

The phrase “PBSS control point” (PCP), as used herein, may include an entity that contains one station (STA) and coordinates access to the WM by STAs that are members of a PBSS.

The phrase “non-PCP station (STA)”, as used herein, may relate to a STA that is not also a PCP.

The phrase “non-PCP/non-AP station (STA)”, as used herein, may relate to a STA that is not a PCP and that is not an AP.

The phrase “PCP/AP”, as used herein, may relate to a STA that is a PCP or an AP.

The phrase “peer to peer (PTP or P2P) communication”, as used herein, may relate to device-to-device communication over a wireless link (“peer-to-peer link”) between a pair of devices. The P2P communication may include, for example, wireless communication over a direct link within a QoS basic service set (BSS), a tunneled direct-link setup (TDLS) link, a STA-to-STA communication in an independent basic service set (IBSS), or the like.

The phrases “directional multi-gigabit (DMG)” and “directional band” (DBand), as used herein, may relate to a frequency band wherein the Channel starting frequency is above 40 GHz.

The phrases “DMG STA” and “mmWave STA (mSTA)” may relate to a STA having a radio transmitter, which is operating on a channel that is within the DMG band.

The phrase “Peer-to-peer” (P2P) network, as used herein, may relate to a network in which a STA in the network can operate as a client or as a server for another STA in the network. The P2P network may allow shared access to resources, e.g., without a need for a central server.

The phrase “P2P device”, as used herein, may relate to a WFA P2P device that may be capable of acting as both a P2P Group Owner and a P2P Client.

The phrase “P2P Client”, as used herein, may relate to a P2P device that may be connected to a P2P Group Owner.

The phrase “P2P Group owner”, as used herein, may relate to an “AP-like” entity, when referring to non-DMG networks, or to a PCP, when referring to DMG networks that may provide and use connectivity between clients.

The phrase “P2P Group”, as used herein, may relate to a set of devices including one P2P Group Owner and zero or more P2P Clients.

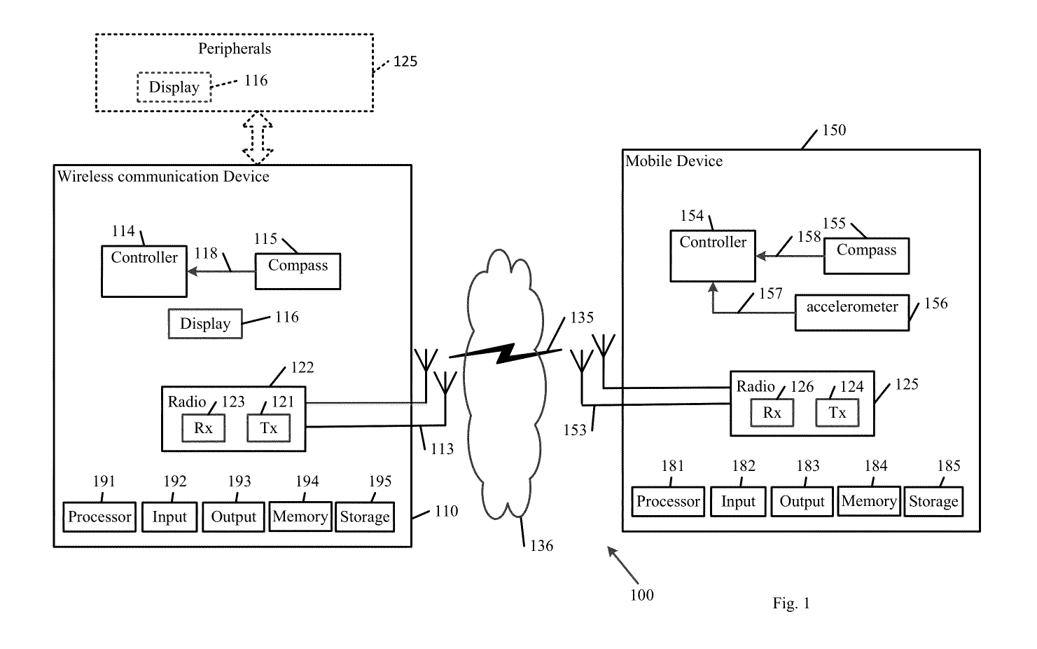

Reference is now made to FIG. 1, which schematically illustrates a block diagram of a system 100, in accordance with some demonstrative embodiments.

As shown in FIG. 1, in some demonstrative embodiments, system 100 may include one or more wireless communication devices capable of communicating content, data, information and/or signals via a wireless medium (WM) 136. For example, system 100 may include a wireless communication device 110 and a mobile device 150.

In some demonstrative embodiments, wireless medium 136 may include, for example, a radio channel, a cellular channel, an RF channel, a Wireless Fidelity (WiFi) channel, an IR channel, and the like. One or more elements of system 100 may optionally be capable of communicating over any suitable wired communication links.

In some demonstrative embodiments, wireless communication device 110 and/or mobile device 150 may include one or more radios to perform wireless communication between wireless communication device 110, mobile device 150, and/or one or more other wireless communication devices. For example, wireless communication device 110 may include a radio 122, and/or mobile device 150 may include a radio 125.

In some demonstrative embodiments, radios 122 and/or 125 may include one or more wireless receivers, able to receive wireless communication signals, RF signals, frames, blocks, transmission streams, packets, messages, data items, and/or data. For example, radio 122 may include a receiver (Rx) 123, and/or radio 125 may include a receiver (Rx) 126.

In some demonstrative embodiments, radios 122 and/or 125 may include one or more wireless transmitters, able to send wireless communication signals, RF signals, frames, blocks, transmission streams, packets, messages, data items, and/or data. For example, radio 122 may include a transmitter (Tx) 121, and/or radio 125 may include a transmitter (Tx) 124.

In some demonstrative embodiments, radios 122 and/or 125 may include modulation elements, demodulation elements, amplifiers, analog to digital and digital to analog converters, filters, and/or the like. For example, radios 122, and/or 125 may include or may be implemented as part of a wireless Network Interface Card (NIC), and the like.

In some demonstrative embodiments, radios 122, and/or 125 may include, or may be associated with, one or more antennas. For example, radio 122 may be associated with one or more antennas 113, and/or radio 125 may be associated with one or more antennas 153.

Antennas 113, and/or 153 may include any type of antennas suitable for transmitting and/or receiving wireless communication signals, blocks, frames, transmission streams, packets, messages and/or data. For example, antennas 113, and/or 153 may include any suitable configuration, structure and/or arrangement of one or more antenna elements, components, units, assemblies and/or arrays. Antennas 113, and/or 153 may include, for example, antennas suitable for directional communication, e.g., using beamforming techniques. For example, antennas 113, and/or 153 may include a phased array antenna, a multiple element antenna, a set of switched beam antennas, and/or the like. In some embodiments, antennas 113, and/or 153 may implement transmit and receive functionalities using separate transmit and receive antenna elements. In some embodiments, antennas 113, and/or 153 may implement transmit and receive functionalities using common and/or integrated transmit/receive elements.

In some demonstrative embodiments, wireless communication device 110 may also include, for example, a processor 191, an input unit 192, an output unit 193, a memory unit 194, and a storage unit 195; and/or mobile device 150 may also include, for example, a processor 181, an input unit 182, an output unit 183, a memory unit 184, and a storage unit 185. Devices 110 and/or 150 may optionally include other suitable hardware components and/or software components. In some demonstrative embodiments, some or all of the components of wireless communication devices 110 and/or 150 may be enclosed in a common housing or packaging, and may be interconnected or operably associated using one or more wired or wireless links. In other embodiments, components of wireless communication device 110 and/or mobile device 150 may be distributed among multiple or separate devices.

Processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. For example, processor 191 executes instructions, for example, of an Operating System (OS) of wireless communication device 110 and/or of one or more suitable applications; and/or processor 181 executes instructions, for example, of an Operating System (OS) of wireless communication device 150 and/or of one or more suitable applications.

Memory unit 194 and/or memory unit 184 may include, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. For example, memory unit 194 and/or storage unit 195, for example, may store data processed by wireless communication device 110; and/or memory unit 184 and/or storage unit 185, for example, may store data processed by wireless communication device 150.

Input unit 192 an/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, a Cathode Ray Tube (CRT) display unit, one or more audio speakers or earphones, or other suitable output devices.

In some demonstrative embodiments, wireless communication device 110 may include a mobile device.

In some demonstrative embodiments, mobile device 150 and/or wireless communication device 110 may include, for example, a User Equipment (UE), a mobile computer, a laptop computer, a notebook computer, a tablet computer, an Ultrabook™ computer, a mobile internet device, a handheld computer, a handheld device, a storage device, a PDA device, a handheld PDA device, an on-board device, an off-board device, a hybrid device, a consumer device, a vehicular device, a non-vehicular device, a portable device, a mobile phone, a cellular telephone, a PCS device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), an “Origami” device or computing device, a video device, an audio device, an A/V device, a gaming device, a media player, a Smartphone, or the like.

In some demonstrative embodiments, device 110 may include a display 116, for example, if device 110 includes a mobile device.

In some demonstrative embodiments, device 110 may include a non-mobile device.

In some demonstrative embodiments, wireless communication device 110 may include a wireless docking device connected to one or more peripherals 125.

In some demonstrative embodiments, device 110 may be configured to provide one or more functionalities to a mobile device, e.g., mobile device 150, in a wireless manner. For example, device 110 may enable the mobile device to utilize peripherals 125 and to use one or more functionalities associated with peripherals 125 in a wireless manner.

In some demonstrative embodiments, peripherals 125 may include display 116.

In some demonstrative embodiments, peripherals 125 may also include a keyboard, a mouse, one or more loudspeakers, a Universal Serial Bus (USB) hub, an external storage, and/or any other peripheral device.

In some demonstrative embodiments, peripherals 125 may be implemented as part of docking device 110. For example, docking device 110 may be embedded as part of display 116.

In other embodiments, peripherals 125 may be implemented as a separate element, which is connected to docking device 110. For example, docking device 110 may include a wireless docking station connected to display 116.

In some demonstrative embodiments, radios 122 and 125 may be configured to establish a wireless communication link 135 between device 110 and mobile device 150 over WM 136.

In one example, device 110 may include a wireless docking station, and mobile device 150 may include a tablet. According to this example, radios 122 and 125 may establish wireless communication link 135 to enable the tablet to utilize display 116, e.g., to display a video from the tablet on display 116.

In another example, device 110 may include a tablet, and mobile device 150 may include a Smartphone. According to this example, radios 122 and 125 may establish wireless communication link 135 to enable data sharing between the tablet and the Smartphone, e.g., to transfer a file from the Smartphone to the tablet.

In some demonstrative embodiments, wireless communication link 135 may include a directional wireless communication link.

In some demonstrative embodiments, wireless communication link 135 may include a directional WiFi link.

In some demonstrative embodiments, wireless communication link 135 may include a directional peer-to-peer (P2P) communication link.

In some demonstrative embodiments, wireless communication link 135 may include a DMG wireless communication link.

In other embodiments, wireless communication link 135 may include any other directional wireless communication link.

In some demonstrative embodiments, antennas 113 and/or 153 may be configured to enable directional communication.

In some demonstrative embodiments, antennas 113 and/or 153 may include directional antennas configured to enable establishment of directional wireless communication link 135. For example, antennas 113 and/or 153 may include a phased array antenna, a multiple element antenna, a set of switched beam antennas, and/or the like.

In some demonstrative embodiments, a directional coverage of antennas 113 and/or 153 may be limited, for example, if wireless communication link 135 includes a DMG wireless communication link.

In some demonstrative embodiments, the directional coverage of antenna 113 may be depend on the orientation of device 110; and/or the directional coverage of antenna 153 may be depend on the orientation of mobile device 150. Accordingly, a coverage area of antenna 113 may be changed, for example, if the orientation of device 110 is changed; and/or a coverage area of device 150 may be changed, for example, if the orientation of device 150 is changed.

In some demonstrative embodiments, a directionality of a device may be correlated with a direction of the directional coverage and/or the coverage area of the antennas of the device.

In one example, the directional coverage of antennas 153 may be directed toward the North, for example, if device 150 is directed to the North.

In another example, the directional coverage of antennas 153 may be directed downward, e.g., toward the ground, for example, if device 150 is placed facedown.

In some demonstrative embodiments, a quality of directional wireless communication link 135 may depend on the directional coverage of antennas 113 and/or 153.

In some demonstrative embodiments, the quality of directional wireless communication link 135 may be poor, e.g., a quality which may not enable exchanging data at a high exchange rate, for example, if the directional coverage of antenna 113 and the directional coverage of antenna 153 do not at least partially overlap.

In some demonstrative embodiments, the directional coverage of antenna 113 and the directional coverage of antenna 153 may not overlap, for example, if antenna 113 and antenna 153 are not directed towards each other.

In some demonstrative embodiments, antenna 113 and antenna 153 may not be directed towards each other, for example, if device 110 and mobile device 150 are not directed towards each other.

In one example, device 110 may be directed to the north, and device 120 may be directed to the east. According to this example, the quality of directional wireless communication link 135 may be poor, for example, since the directional coverage of antenna 113 is directed toward the north, and the directional coverage of antenna 153 is directed toward the south. Accordingly, transmissions from device 110 may not reach mobile device 150, and/or transmissions from mobile device 150 may not reach device 110.

For example, device 110 may include a tablet, and mobile device 150 may include a Smartphone. According to this example, the quality of directional wireless communication link 135 may be poor, for example, if the tablet and the Smartphone are not directed towards each other.

In some demonstrative embodiments, the quality of directional wireless communication link 135 may be poor, for example, if the directional coverage of antenna 153 is directed towards the ground

In some demonstrative embodiments, when the directional coverage of antenna 153 is directed towards the ground, a transmission power of antenna 153 may be absorbed in the ground or in an object placed beneath mobile device 150. For example, only back lobes and reflections of the transmission power of antenna 153 may be directed to antenna 113, e.g., if antenna 153 is directed downward.

In some demonstrative embodiments, the directional coverage of antenna 153 may be directed towards the ground, for example, if mobile device 150 is placed facedown, e.g., on a table.

In one example, device 110 may include a wireless docking station, and mobile device 150 may include a Smartphone. According to this example, the quality of directional wireless communication link 135 may be poor, for example, if the Smartphone is held or placed facedown, e.g., on a table or any other surface.

Some demonstrative embodiments may enable device 110 to advise a user of mobile device 150 to change an orientation of mobile device 150, for example, in order to improve the quality of directional wireless communication link 135, e.g., as described below.

In some demonstrative embodiments, device 110 may include a controller 114 configured to receive an orientation feedback from mobile device 150, for example, subsequent to an establishment of directional wireless communication link 135.

In some demonstrative embodiments, the orientation feedback may include an indication of an estimated orientation of mobile device 150.

In some demonstrative embodiments, controller 114 may output a recommendation to change the orientation of mobile device 150, for example, based on the estimated orientation of mobile device 150, e.g., as described below.

In some demonstrative embodiments, controller 114 may instruct, control, request and/or cause one or more elements of output unit 193 to output the recommendation to change the orientation of mobile device 150.

In some demonstrative embodiments, the output may include a visual output.

In one example, controller 114 may instruct display 116 to display a recommendation message to change the orientation of mobile device 150, e.g., as described below.

In some demonstrative embodiments, the output may include an audio output.

In one example, controller 114 may instruct a speaker of device 110 to sound a recommendation message to change the orientation of mobile device 150.

In other embodiments, the output may include any other output generated by any other output unit 193 of device 110.

In some demonstrative embodiments, controller 114 may output the recommendation to change the orientation of mobile device 150 in the form of a message to mobile device 150.

In one example, controller 114 may send to mobile device 150 a recommendation message including the recommendation to change the orientation of mobile device 150, for example, to enable device 150 to output the recommendation.

In some demonstrative embodiments, mobile device 150 may receive the message and may instruct, control, request and/or cause output unit 183 to output the recommendation to change the orientation of mobile device 150, e.g., via a display and/or a speaker of mobile device 150.

In some demonstrative embodiments, mobile device 150 may include a controller 154 configured to estimate the orientation of mobile device 150.

In some demonstrative embodiments, controller 154 may send the orientation feedback to device 110.

In some demonstrative embodiments, controller 154 may send the orientation feedback to device 110, e.g., subsequent to the establishment of directional wireless communication link 135.

In some demonstrative embodiments, controller 154 may send the orientation feedback to device 110, e.g., in response to an orientation request from device 110.

In some demonstrative embodiments, controller 114 may send the orientation request from device 110 to mobile device 150, e.g., subsequent to the establishment of directional wireless communication link 135.

In some demonstrative embodiments, controller 114 may send the orientation request, for example, if the quality of directional wireless communication link 135 is below a quality threshold.

In some demonstrative embodiments, the quality threshold may include a quality threshold corresponding to a predefined Modulation and Coding Scheme (MCS), e.g., an MCS lesser than MCS6.

In some demonstrative embodiments, controller 114 may be configured to monitor an MCS supported by directional wireless communication link 135.

In some demonstrative embodiments, controller 114 may send the orientation request, for example, if the MCS of directional wireless communication link 135 is lesser than the predefined MCS, e.g., lesser than MCS6.

In other embodiments, the quality threshold may relate to any other parameter corresponding to a quality of wireless communication link 135, e.g. a throughput parameter, a Signal to Noise Ratio (SNR) parameter, an Error Vector Magnitude (EVM), a Quality of Service (QoS) parameter, and/or any other parameter.

In some demonstrative embodiments, controller 154 may receive the orientation request from device 110, for example, if the quality of directional wireless communication link 135 is below the quality threshold.

In some demonstrative embodiments, the orientation feedback may include one or more orientation measurements of mobile device 150, e.g., as described below.

In some demonstrative embodiments, the orientation feedback may include an accelerometer measurement of mobile device 150.

In some demonstrative embodiments, mobile device 150 may include an accelerometer 156 to measure an acceleration of device 150.

In some demonstrative embodiments, accelerometer 156 may be configured to sense gravitational acceleration of mobile device 150.

In some demonstrative embodiments, the gravitational acceleration may be utilized, for example, to determine a tilt angle of mobile device 150.

In some demonstrative embodiments, the orientation feedback may include an indication (“facedown indication”) indicating that device 150 is facedown.

In one example, the facedown indication may include a predefined value, e.g., “1”, indicating device 150 is facedown.

In another example, the facedown indication may include a tilt angle indicating device 150 is facedown, for example, a tilt angle greater than ninety degrees, e.g., a roll angle greater than ninety degrees and/or a pitch angle greater than ninety degrees.

In some demonstrative embodiments, device 110 may receive the orientation feedback including the accelerometer measurement and/or the facedown indication.

In some demonstrative embodiments, controller 114 may determine whether or not device 150 is facedown, for example, based on the orientation feedback.

In one example, controller 114 may determine that device 150 is facedown, for example, if the facedown indication includes the predefined value set to “1”.

In another example, controller 114 may determine that device 150 is facedown, for example, if the accelerometer measurement and/or the facedown indication indicate a tilt angle of device 150, which is greater than ninety degrees.

In some demonstrative embodiments, controller 114 may instruct display 116 to display a recommendation to invert device 150, for example, when the orientation-feedback indicates that device 150 is facedown.

Additionally or alternatively, controller 114 may instruct any other output unit 193, e.g., a speaker, to output the recommendation to invert device 150.

Additionally or alternatively, controller 114 may send to mobile device 150 a message recommending to invert mobile device 150, and mobile device 150 may output the recommendation to the user of mobile device 150, e.g., via output 183.

In some demonstrative embodiments, controller 114 may instruct display 116 to display the recommendation to invert device 150, for example, based on the accelerometer measurement and/or the facedown indication.

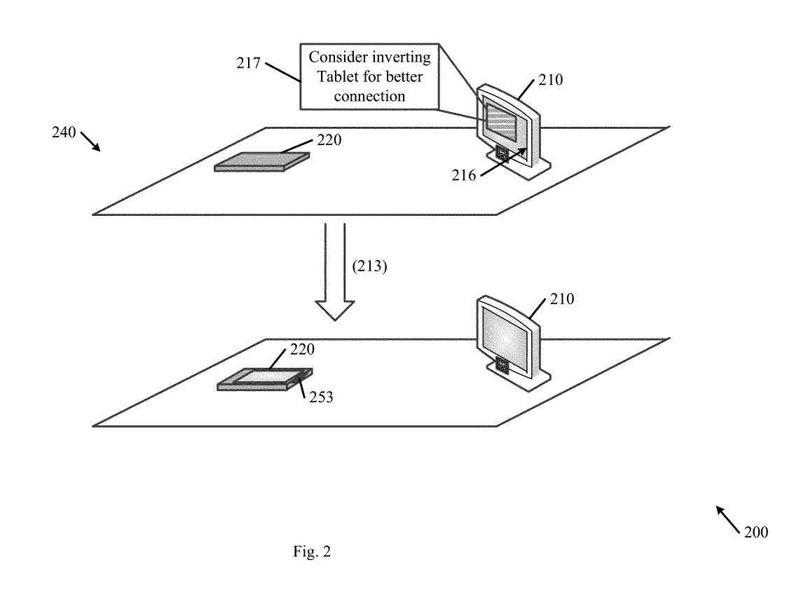

In some demonstrative embodiments, device 116 may display the recommendation, for example, including a message advising the user to invert mobile device 150, e.g., as described below with reference to FIG. 2.

In some demonstrative embodiments, the orientation feedback may include a directionality of mobile device 150.

In some demonstrative embodiments, the directionality of mobile device 150 may include a compass direction of mobile device 150.

In some demonstrative embodiments, mobile device 150 may include a compass 155 to measure the compass direction of mobile device 150.

In some demonstrative embodiments, compass 155 may be configured to measure a directionality of mobile device 150 with respect to a direction of the magnetic north. For example, compass 155 may include a magnetometer configured to sense magnetic fields.

In some demonstrative embodiments, compass 155 may be configured to provide a value representing an angle between the magnetic north and the directionality of mobile device 150.

In some demonstrative embodiments, controller 114 may receive from mobile device 150 the orientation feedback including the directionality of mobile device 150, for example, subsequent to sending the orientation request to mobile device 150 and/or subsequent to the establishment of directional wireless communication link 135.

In some demonstrative embodiments, controller 114 may receive the orientation feedback including the directionality of mobile device 150.

In some demonstrative embodiments, the directionality of mobile device 150 may include, for example, the compass direction of mobile device 150.

In some demonstrative embodiments, the compass direction may include a value representing the angle between the magnetic north and the directionality of mobile device 150.

In some demonstrative embodiments, controller 114 may determine a relative directionality between device 110 and mobile device 150, for example, based on the directionality of mobile device 150.

In some demonstrative embodiments, controller 114 may determine the relative directionality between device 110 and mobile device 150, for example, based on the compass direction of device 150 and a compass direction of device 110.

In some demonstrative embodiments, wireless communication device 110 may include a compass 115 to measure the compass direction of device 110.

In some demonstrative embodiments, compass 115 may be configured to measure a directionality of wireless communication device 110 with respect to a direction of the magnetic north. For example, compass 115 may include a magnetometer configured to sense magnetic fields.

In some demonstrative embodiments, compass 115 may be configured to provide a value representing an angle between the magnetic north and the directionality of device 110.

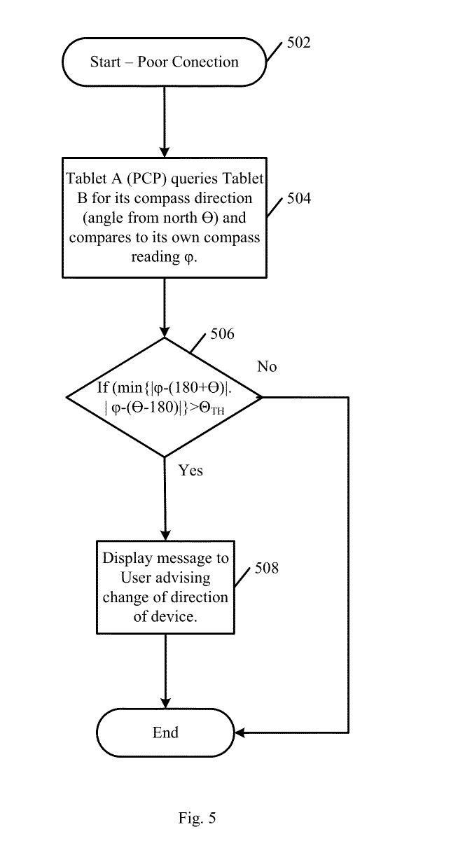

In some demonstrative embodiments, controller 114 may determine the relative directionality between mobile device 150 and device 110 based on the angle between the magnetic north and the directionality of device 110 and the angle between the magnetic north and the directionality of mobile device 150, e.g., as described below with reference to FIG. 5.

In some demonstrative embodiments, controller 114 may instruct display 116 to display the recommendation message, for example, based on the relative directionality between device 110 and mobile device 150.

Additionally or alternatively, controller 114 may instruct any other output unit 193, e.g., a speaker, to output the recommendation to invert device 150.

Additionally or alternatively, controller 114 may send to mobile device 150 a message recommending to invert mobile device 150, and mobile device 150 may output the recommendation to the user of mobile device 150, e.g., via output 183.

In some demonstrative embodiments, controller 114 may instruct display 116 to display the recommendation message on display 116, for example, based on a comparison between the compass direction of device 110 and the compass direction of mobile device 150.

In some demonstrative embodiments, controller 114 may instruct display 116 to display the recommendation message on display 116, for example, if the relative directionality between device 110 and mobile device 150 is greater than a predefined threshold.

For example, controller 114 may instruct display 116 to display the recommendation message, for example, if device 110 and mobile device 150 are not directed towards each other.

In one example, device 110 and mobile device 150 may not be directed towards each other, for example, if the relative directionality between device 110 and mobile device 150 is greater than the predefined threshold, e.g., greater than five degrees.

In some demonstrative embodiments, the recommendation message may advise the user of mobile device 150 to change the directionality of mobile device 150. For example, the recommendation message may advise the user of mobile device 150 to direct mobile device 150 toward device 110.

In some demonstrative embodiments, display 116 may display the recommendation, for example, including a message advising the user to direct mobile device 150 toward device 110, e.g., as described below with reference to FIG. 5. In one example, the recommendation message may direct the user as to a direction mobile device 150 is to be turned, e.g., “turn device left” or “turn device right”.

In some demonstrative embodiments, providing the recommendation message to the user of mobile device 150, e.g., by displaying the recommendation message on display 116 and/or outputting the recommendation message by any other output of devices 110 and/or 150, may enable to increase the quality of directional wireless communication link 135, which may enable, for example, to exchange data between mobile device 150 and device 110 at an increased rate and/or throughput.

Reference is now made to FIG. 2, which schematically illustrates a deployment of a system 200, in accordance with some demonstrative embodiments. For example, system 200 may perform the functionality of system 100 (FIG. 1).

In some demonstrative embodiments, system 200 may include a wireless communication device 210, and/or a mobile device 220. For example, wireless communication device 210 may perform the functionality of wireless communication device 110 (FIG. 1), and/or wireless communication device 220 may perform the functionality of mobile device 150 (FIG. 1).

In one example, wireless communication device 210 may include a docking device embedded in a display 216, and/or mobile device 220 may include a tablet. For example, display 216 may perform functionality of display 116 (FIG. 1).

As shown in FIG. 2, mobile device 220 may be facedown (240).

As shown in FIG. 2, antennas 253 of mobile device 220 may be facedown, for example, when mobile device 220 is facedown.

In some demonstrative embodiments, controller 114 (FIG. 1) may determine whether or not mobile device 220 is facedown, for example, based on the orientation feedback from mobile device 220, e.g., as described above.

In some demonstrative embodiments, controller 114 (FIG. 1) may instruct display 216 to display a recommendation message 217.

As shown in FIG. 2, recommendation message 217 may include a message advising a user of mobile device 220 to invert mobile device 220, e.g., the message “Consider inverting tablet for better connection”, for example, if controller 114 (FIG. 1) determines that mobile device 220 is facedown.

As shown in FIG. 2, mobile device 220 may be inverted (213), e.g., by the user of mobile device 220, for example, responsive to recommendation message 217.

In some demonstrative embodiments, a quality of directional wireless communication link 135 (FIG. 1) may be improved, for example, as a result from inverting (213) mobile device 220, e.g., from facing down to facing up.

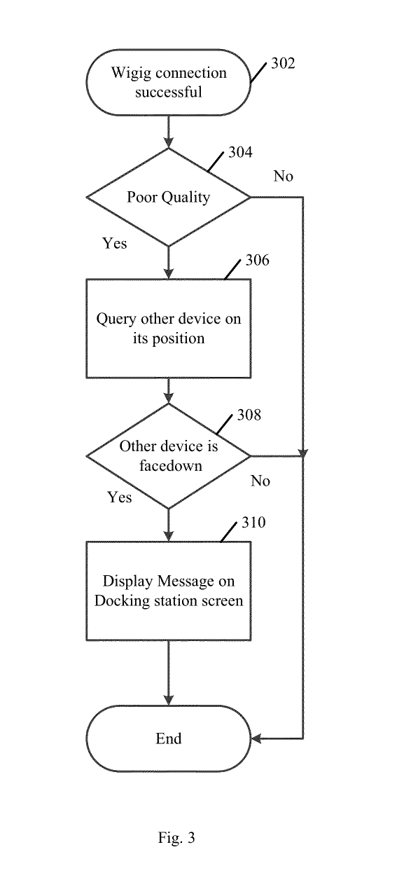

Reference is made to FIG. 3, which schematically illustrates a method of advising a user of a mobile device to change an orientation of the mobile device, in accordance with some demonstrative embodiments. For example, one or more of the operations of the method of FIG. 3 may be performed by a wireless communication system 100 (FIG. 1); a wireless communication device, e.g., device 110 (FIG. 1), and/or device 210 (FIG. 2); a mobile device, e.g., mobile device 150 (FIG. 1), and/or mobile device 220 (FIG. 2); a controller, e.g., controller 114 (FIG. 1), and/or controller 154 (FIG. 1); and/or a radio, e.g., radio 122 (FIG. 1), and/or radio 125 (FIG. 1).

As indicated at block 302, the method may include establishing a directional wireless communication link between a first wireless communication device and a second wireless communication device. For example, radio 122 (FIG. 1) and radio 125 (FIG. 1) may establish directional wireless communication link 135 (FIG. 1) between device 110 (FIG. 1) and mobile device 150 (FIG. 1), e.g., as described above.

As indicated at block 304, the method may include determining whether or not a quality of the directional wireless communicational link is below a quality threshold. For example, controller 114 (FIG. 1) may determine whether or not the quality of directional wireless communication link 135 (FIG. 1) is below the quality threshold, e.g., as described above.

As indicated at block 306, the method may include sending an orientation request from the first wireless communication device to the second wireless communication device, for example, if the quality of the directional wireless communication link is below the quality threshold. For example, controller 114 (FIG. 1) may send the orientation request from device 110 (FIG. 1) to mobile device 150 (FIG. 1), for example, if the quality of directional wireless communication link 135 (FIG. 1) is below the quality threshold, e.g., as described above.

As indicated at block 308, the method may include determining whether or not the wireless communication device is facedown. For example, controller 114 (FIG. 1) may determine whether or not mobile device 150 (FIG. 1) is facedown, for example, based on the orientation feedback from mobile device 150 (FIG. 1), e.g., as described above.

As indicated at block 310, the method may include displaying a recommendation to invert the second wireless communication device, for example, if the orientation feedback indicates that the second wireless communication device is facedown. For example, controller 114 (FIG. 1) may instruct display 116 (FIG. 1) to display the recommendation to invert mobile device 150 (FIG. 1), for example, when the orientation feedback indicates that mobile device 150 (FIG. 1) is facedown, e.g., as described above.

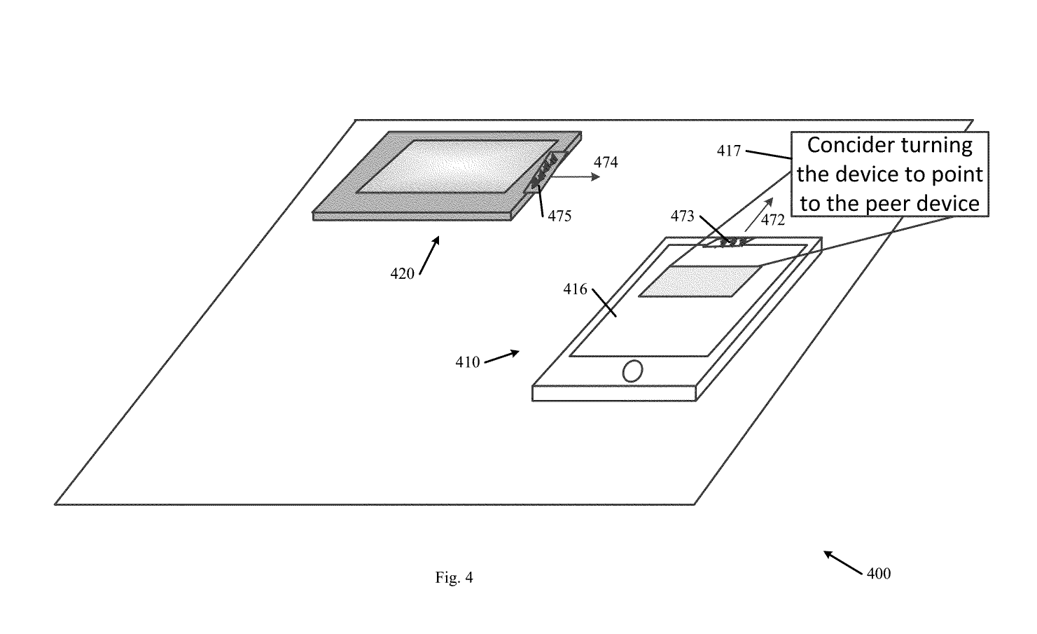

Reference is now made to FIG. 4, which schematically illustrates a deployment of a system 400, in accordance with some demonstrative embodiments. For example, system 400 may perform the functionality of system 100 (FIG. 1).

In some demonstrative embodiments, system 400 may include a wireless communication device 410, and a mobile device 420. For example, wireless communication device 410 may perform the functionality of wireless communication device 110 (FIG. 1), and/or mobile device 420 may perform the functionality of mobile device 150 (FIG. 1).

In one example, wireless communication device 410 may include a tablet and/or mobile device 420 may include a tablet.

In another example, wireless communication device 410 may include any other mobile or non-mobile device, e.g., a Smartphone or a PC, and mobile device 420 may include any other mobile device, e.g., a laptop computer, or a Smartphone.

As shown in FIG. 4, wireless communication device 410 and mobile device 420 may not be directed towards each other.

As shown in FIG. 4, an antenna 475 of mobile device 420 may be directed to a first direction 474, and/or an antenna 473 of device 410 may be directed to a second direction 472, e.g., different from direction 474. For example, direction 474 and direction 472 might not face each other. For example, as shown in FIG. 4, direction 474 may be substantially orthogonal to direction 472.

In some demonstrative embodiments, controller 114 (FIG. 1) may determine a relative directionality between wireless communication device 410 and mobile device 420, for example, based on an orientation feedback from mobile device 420, e.g., as described above

In some demonstrative embodiments, controller 114 (FIG. 1) may determine that the relative directionality between wireless communication device 410 and mobile device 420 is greater than a predefined threshold, for example, based on a comparison between the orientation feedback from mobile device 420 and an orientation of device 410.

In some demonstrative embodiments, controller 114 (FIG. 1) may instruct wireless communication device 410 to display a recommendation message 417 on a display 416, for example, if the relative directionality between devices 410 and 420 is greater than the predefined threshold. For example, display 416 may perform functionality of display 116 (FIG. 1).

As shown in FIG. 4, recommendation message 417 may include a message advising a user of mobile device 420 to change the directionality of mobile device 220, e.g., “Consider turning the device to point to the peer device”, for example, if wireless communication device 410 and mobile device 420 are not directed towards each other.

In some demonstrative embodiments, the user of mobile device 420 may rotate and/or move mobile device 420, e.g., responsive to message 417, for example, to change the directionality of mobile device 420 such that mobile device 420 may be directed towards device 410.

In some demonstrative embodiments, the quality of directional wireless communication link 135 (FIG. 1) may be improved, for example, as a result of changing of the directionality of mobile device 420.

Reference now is made to FIG. 5, which schematically illustrates a method of advising a user of a mobile device to change an orientation of the mobile device, in accordance with some demonstrative embodiments. For example, one or more of the operations of the method of FIG. 5 may be performed by a wireless communication system 100 (FIG. 1); a wireless communication device, e.g., device 110 (FIG. 1), and/or device 410 (FIG. 4); a mobile device, e.g., mobile device 150 (FIG. 1) and/or device 420 (FIG. 4); a controller, e.g., controller 114 (FIG. 1), and/or controller 154 (FIG. 1); and/or a radio, e.g., radio 122 (FIG. 1), and/or radio 125 (FIG. 1).

As indicated at block 502, the method may include establishing a directional wireless communicational link between first and second wireless communication devices. The directional wireless communicational link may have a quality below a quality threshold. For example, radio 122 (FIG. 1) and radio 125 (FIG. 1) may establish directional wireless communication link 135 (FIG. 1) between device 110 (FIG. 1) and mobile device 150 (FIG. 1). Controller 114 (FIG. 1) may detect that directional wireless communication link 135 (FIG. 1) has a quality below the quality threshold, e.g., as described above.

As indicated at block 504, the method may include sending an orientation request from the first wireless communication device to the second wireless communication device. For example, controller 114 (FIG. 1) may send the orientation request to mobile device 150 (FIG. 1), e.g., as described above.

As also indicated at block 504, the method may include receiving an orientation feedback from the second wireless communication device, the orientation feedback including a compass direction of the second wireless communication device. For example, controller 114 (FIG. 1) may receive the orientation feedback from mobile device 150 (FIG. 1), the orientation feedback including the compass direction of mobile device 150 (FIG. 1), e.g., as described above.

As also indicated at block 504, the method may include comparing a compass direction of the first device to the compass direction of the second wireless communication device. For example, controller 114 (FIG. 1) may compare between the compass direction of device 110 (FIG. 1) and the compass direction of mobile device 150 (FIG. 1).

As indicated at block 506, the method may include determining a relative directionality between the first and second wireless communication devices, based on the compass direction of the first communication wireless device and the compass direction of the second wireless communication device. For example, controller 114 (FIG. 1) may determine the relative directionality between device 110 (FIG. 1) and mobile device 150 (FIG. 1), based on the compass direction of device 110 (FIG. 1) and the compass direction of mobile device 150 (FIG. 1).

In some demonstrative embodiments, controller 114 (FIG. 1) may determine if the relative directionality between device 110 (FIG. 1) and mobile device 150 (FIG. 1) is greater than a predefined relative directionality threshold, denoted Φ_{TH}, e.g., for example, by determining whether the following condition is met:

(min{|φ−(180+Φ)|·|φ−(Φ−180|)}>Φ_{TH}) (1)

wherein Φ denotes an angle between mobile device 420 and the magnetic north, and φ denotes an angle between wireless communication device 410 and the magnetic north.

In other embodiments, any other condition may be used to determine whether or not the relative directionality between device 410 and mobile device 420 is greater than the predefined relative directionality threshold.

As indicated at block 508, the method may include displaying a recommendation to change the directionality of the second wireless communication device, for example, if the relative directionality between the first and second devices is greater than the predefined relative directionality threshold. For example, controller 114 (FIG. 1) may instruct display 116 (FIG. 1) to display the recommendation to change the directionality of mobile device 150 (FIG. 1), for example, if the relative directionality between device 110 (FIG. 1) and mobile device 150 (FIG. 1) is greater than the predefined relative directionality threshold, e.g., as described above.

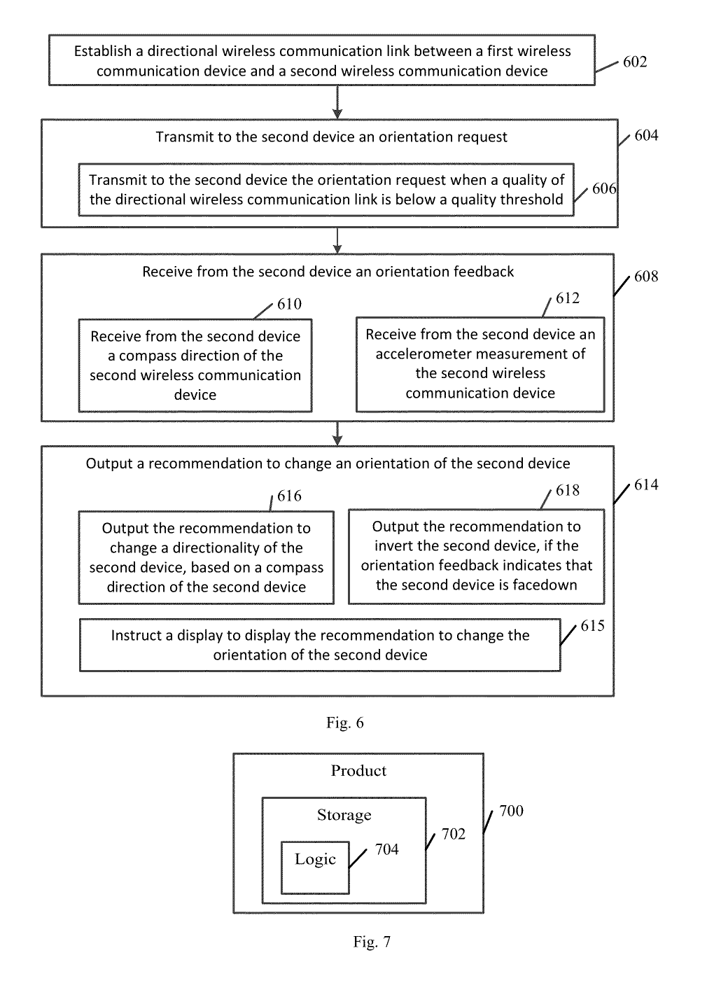

Reference now is made to FIG. 6, which schematically illustrates a method of communicating orientation information between wireless communication devices, in accordance with some demonstrative embodiments. For example, one or more of the operations of the method of FIG. 6 may be performed by a wireless communication system 100 (FIG. 1); a wireless communication device, e.g., device 110 (FIG. 1); a mobile device, e.g., mobile device 150 (FIG. 1); a controller, e.g., controller 114 (FIG. 1), and/or controller 154 (FIG. 1); and/or a radio, e.g., radio 122 (FIG. 1), and/or radio 125 (FIG. 1).

As indicated at block 602, the method may include establishing a directional wireless communication link between a first wireless communication device and a second wireless communication device. For example, radio 122 (FIG. 1) and radio 125 (FIG. 1) may establish directional wireless communication link 135 (FIG. 1) between device 110 (FIG. 1) and mobile device 150 (FIG. 1), e.g., as described above.

As indicated at block 604, the method may include transmitting an orientation request to the second wireless communication device. For example, controller 114 (FIG. 1) may send the orientation request to mobile device 150 (FIG. 1), e.g., as described above.

As indicated at block 606, transmitting the orientation request to the second wireless communication device may include transmitting the orientation request to the second wireless communication device, for example, when a quality of the directional wireless communication link is below a quality threshold. For example, controller 114 (FIG. 1) may send the orientation request to mobile device 150 (FIG. 1), for example, when the quality of the directional wireless communication link 135 (FIG. 1) is below the quality threshold, e.g., as described above.

As indicated at block 608, the method may include receiving an orientation feedback from the second wireless communication device. For example, controller 114 (FIG. 1) may receive the orientation feedback from mobile device 150 (FIG. 1), e.g., as described above.

In some demonstrative embodiments, the orientation feedback may be received in response to the orientation request, e.g., as described above. In other embodiments, the orientation feedback may be received independently from the orientation request, e.g., even if an orientation request is not sent. In one example, mobile device 150 (FIG. 1) may be configured to send the orientation feedback to device 110 (FIG. 1, e.g., upon establishing link 135 (FIG. 1), upon mobile device 150 (FIG. 1) detecting a poor quality of link 135 (FIG. 1), and/or based on any other criteria.

As indicated at block 610, receiving the orientation feedback from the second wireless communication device may include receiving from the second wireless communication device a compass direction of the second wireless communication device. For example, controller 114 (FIG. 1) may receive from mobile device 150 (FIG. 1) the compass direction of mobile device 150 (FIG. 1), e.g., as described above.

As indicated at block 612, receiving the orientation feedback from the second wireless communication device may include receiving from the second wireless communication device an accelerometer measurement of the second wireless communication device. For example, controller 114 (FIG. 1) may receive from mobile device 150 (FIG. 1) the accelerometer measurement of mobile device 150 (FIG. 1), e.g., as described above.

As indicated at block 614, the method may include outputting a recommendation to change an orientation of the second wireless communication device. For example, controller 114 (FIG. 1) may instruct output unit 193 (FIG. 1) to output the recommendation to change the orientation of mobile device 150 (FIG. 1), e.g., as described above.

As indicated at block 615, the method may include instructing a display to display the recommendation to change an orientation of the second wireless communication device. For example, controller 114 (FIG. 1) may instruct display 116 (FIG. 1) to display the recommendation to change the orientation of mobile device 150 (FIG. 1), e.g., as described above.

As indicated at block 616, outputting the recommendation to change the orientation of the second wireless communication device may include outputting a recommendation to change a directionality of the second wireless communication device, for example, based on a compass direction of the second wireless communication device. For example, controller 114 (FIG. 1) may instruct display 116 (FIG. 1) to display the recommendation to change the directionality of mobile device 150 (FIG. 1), for example, based on the compass direction of mobile device 150 (FIG. 1), e.g., as described above.

As indicated at block 618, outputting the recommendation to change the orientation of the second wireless communication device may include outputting a recommendation to invert the second wireless communication device, for example, if the orientation feedback indicates that the second wireless communication device is facedown. For example, controller 114 (FIG. 1) may instruct display 116 (FIG. 1) to display the recommendation to invert mobile device 150 (FIG. 1), for example, if the orientation feedback indicates that mobile device 150 (FIG. 1) is facedown, e.g., as described above.

Reference is made to FIG. 7, which schematically illustrates a product of manufacture 700, in accordance with some demonstrative embodiments. Product 700 may include one or more tangible computer-readable non-transitory storage media 702 to store logic 704, which may be used, for example, to perform at least part of the functionality of mobile device 150 (FIG. 1), device 110 (FIG. 1), mobile device 220 (FIG. 2), device 210 (FIG. 2), mobile device 420 (FIG. 4), device 410 (FIG. 4), radio 122 (FIG. 1), radio 125 (FIG. 1), controller 114 (FIG. 1), controller 154 (FIG. 1), and/or to perform one or more operations of the method of FIGS. 3, 5 and/or 6. The phrase “non-transitory machine-readable medium” is directed to include all computer-readable media, with the sole exception being a transitory propagating signal.

In some demonstrative embodiments, product 700 and/or media 702 may include one or more types of computer-readable storage media capable of storing data, including volatile memory, non-volatile memory, removable or non-removable memory, erasable or non-erasable memory, writeable or re-writeable memory, and the like. For example, machine-readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), Compact Disk ROM (CD-ROM), Compact Disk Recordable (CD-R), Compact Disk Rewriteable (CD-RW), flash memory (e.g., NOR or NAND flash memory), content addressable memory (CAM), polymer memory, phase-change memory, ferroelectric memory, silicon-oxide-nitride-oxide-silicon (SONOS) memory, a disk, a floppy disk, a hard drive, an optical disk, a magnetic disk, a card, a magnetic card, an optical card, a tape, a cassette, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative embodiments, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative embodiments, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, such as C, C++, Java, BASIC, Matlab, Pascal, Visual BASIC, assembly language, machine code, and the like.

### Examples

The following examples pertain to further embodiments.

Example 1 includes an apparatus comprising a radio to receive at a first wireless communication device an orientation feedback from a second wireless communication device, subsequent to establishment of a directional wireless communication link with the second wireless communication device, the orientation feedback including an indication of an estimated orientation of the second wireless communication device; and a controller to output a recommendation to change an orientation of the second wireless communication device, based on the estimated orientation of the second wireless communication device.

Example 2 includes the subject matter of Example 1, and optionally, wherein the radio is to send to the second wireless communication device a request to send the orientation feedback.

Example 3 includes the subject matter of Example 2, and optionally, wherein the radio is to send the request when a quality of the directional wireless communication link is below a quality threshold.

Example 4 includes the subject matter of any one of Examples 1-3, and optionally, wherein the controller is to determine a relative directionality between the first and second wireless communication devices based on the orientation feedback, and wherein the controller is to output the recommendation based on the relative directionality.

Example 5 includes the subject matter of any one of Examples 1-4, and optionally, wherein the orientation feedback comprises a compass direction of the second wireless communication device, and wherein the controller is to output the recommendation based on the compass direction of the second wireless communication device and a compass direction of the first wireless communication device.

Example 6 includes the subject matter of any one of Examples 1-4, and optionally, wherein the controller is to instruct the first wireless device to output a recommendation to invert the second wireless communication device, when the orientation feedback is to indicate the second wireless communication device is facedown.

Example 7 includes the subject matter of any one of Examples 1-6, and optionally, wherein the controller is to instruct an output unit of the first wireless communication device to output the recommendation.

Example 8 includes the subject matter of any one of Examples 1-7, and optionally, wherein the controller is to instruct a display of the first wireless communication device to display the recommendation.

Example 9 includes the subject matter of any one of Examples 1-8, and optionally, wherein the radio is to send to the second wireless communication device a message including the recommendation to change the orientation of the second wireless communication device.

Example 10 includes the subject matter of any one of Examples 1-9, and optionally, wherein the orientation feedback includes one or more orientation measurements of the second wireless communication device.

Example 11 includes the subject matter of any one of Examples 1-10, and optionally, wherein the orientation feedback includes a compass direction of the second wireless communication device.

Example 12 includes the subject matter of any one of Examples 1-11, and optionally, wherein the orientation feedback includes an accelerometer measurement of the second wireless communication device.

Example 13 includes the subject matter of any one of Examples 1-12, and optionally, wherein the directional wireless communication link comprises a Directional Multi-Gigabit (DMG) link.

Example 14 includes an apparatus comprising a radio to establish a directional wireless communication link between a first wireless communication device and a second wireless communication device; and a controller to send an orientation request from the first wireless communication device to the second wireless communication device, subsequent to the establishment of the directional wireless communication link, the controller to receive at the first wireless communication device an orientation feedback from the second wireless communication device in response to the orientation request, the orientation feedback including an indication of an estimated orientation of the second wireless communication device.

Example 15 includes the subject matter of Example 14, and optionally, wherein, based on the estimated orientation of the second wireless communication device, the controller is to output a recommendation to change an orientation of the second wireless communication device.

Example 16 includes the subject matter of Example 15, and optionally, wherein the controller is to determine a relative directionality between the first and second wireless communication devices based on the orientation feedback, and wherein the controller is to output the recommendation based on the relative directionality.

Example 17 includes the subject matter of Example 15 or 16, and optionally, wherein the orientation feedback comprises a compass direction of the second wireless communication device, and wherein the controller is to output the recommendation based on the compass direction of the second wireless communication device and a compass direction of the first wireless communication device.

Example 18 includes the subject matter of Example 15 or 16, and optionally, wherein the controller is to instruct the first wireless communication device to output a recommendation to invert the second wireless communication device, when the orientation feedback is to indicate the second wireless communication device is facedown.

Example 19 includes the subject matter of any one of Examples 15-18, and optionally, wherein the controller is to instruct an output unit of the first wireless communication device to output the recommendation.

Example 20 includes the subject matter of any one of Examples 15-19, and optionally, wherein the controller is to instruct a display of the first wireless communication device to display the recommendation.

Example 21 includes the subject matter of any one of Examples 15-20, and optionally, wherein the radio is to send to the second wireless communication device a message including the recommendation to change the orientation of the second wireless communication device.

Example 22 includes the subject matter of any one of Examples 14-21, and optionally, wherein the radio is to send the orientation request when a quality of the directional wireless communication link is below a quality threshold.

Example 23 includes the subject matter of any one of Examples 14-22, and optionally, wherein the orientation feedback includes one or more orientation measurements of the second wireless communication device.

Example 24 includes the subject matter of any one of Examples 14-23, and optionally, wherein the orientation feedback includes a compass direction of the second wireless communication device.

Example 25 includes the subject matter of any one of Examples 14-24, and optionally, wherein the orientation feedback includes an accelerometer measurement of the second wireless communication device.

Example 26 includes the subject matter of any one of Examples 14-25, and optionally, wherein the directional wireless communication link comprises a Directional Multi-Gigabit (DMG) link.

Example 27 includes an apparatus comprising a radio to establish a directional wireless communication link between a first wireless communication device and a second wireless communication device; and a controller to receive at the first wireless communication device an orientation request from the second wireless communication device, subsequent to the establishment of the directional wireless communication link, the controller to send to the second wireless communication device an orientation feedback in response to the orientation request, the orientation feedback including an indication of an estimated orientation of the first wireless communication device.

Example 28 includes the subject matter of Example 27, and optionally, wherein the controller is to receive the orientation request when a quality of the directional wireless communication link is below a quality threshold.

Example 29 includes the subject matter of Example 27 or 28, and optionally, wherein the orientation feedback comprises a compass direction of the first wireless communication device.

Example 30 includes the subject matter of any one of Examples 27-29, and optionally, wherein the orientation feedback is to indicate whether or not the first wireless communication device is facedown.

Example 31 includes the subject matter of any one of Examples 27-30, and optionally, wherein the orientation feedback includes one or more orientation measurements of the first wireless communication device.

Example 32 includes the subject matter of any one of Examples 27-31, and optionally, wherein the orientation feedback includes an accelerometer measurement of the first wireless communication device.

Example 33 includes the subject matter of any one of Examples 27-32, and optionally, wherein the controller is to receive from the second wireless communication device a message including a recommendation to change the orientation of the first wireless communication device, and wherein the controller is to instruct an output unit of the first wireless communication device to output the recommendation.

Example 34 includes the subject matter of any one of Examples 27-33, and optionally, wherein the controller is to receive from the second wireless communication device a message including a recommendation to change the orientation of the first wireless communication device, and wherein the controller is to instruct a display of the first wireless communication device to display the recommendation.

Example 35 includes the subject matter of any one of Examples 27-34, and optionally, wherein the directional wireless communication link comprises a Directional Multi-Gigabit (DMG) link.

Example 36 includes a first wireless communication device comprising at least one antenna; a memory; a processor; a radio to establish a directional wireless communication link with a second wireless communication device; and a controller to receive an orientation feedback from the second wireless communication device, subsequent to establishment of the directional wireless communication link, the orientation feedback including an indication of an estimated orientation of the second wireless communication device, wherein, based on the estimated orientation of the second wireless communication device, the controller is to output a recommendation to change an orientation of the second wireless communication device.

Example 37 includes the subject matter of Example 36, and optionally, wherein the radio is to send to the second wireless communication device a request to send the orientation feedback.

Example 38 includes the subject matter of Example 37, and optionally, wherein the radio is to send the request when a quality of the directional wireless communication link is below a quality threshold.

Example 39 includes the subject matter of any one of Examples 36-38, and optionally, wherein the controller is to determine a relative directionality between the first and second wireless communication devices based on the orientation feedback, and wherein the controller is to output the recommendation based on the relative directionality.

Example 40 includes the subject matter of any one of Examples 36-39, and optionally, wherein the orientation feedback comprises a compass direction of the second wireless communication device, and wherein the controller is to output the recommendation based on the compass direction of the second wireless communication device and a compass direction of the first wireless communication device.

Example 41 includes the subject matter of any one of Examples 36-39, and optionally, wherein the controller is to instruct the first wireless device to output a recommendation to invert the second wireless communication device, when the orientation feedback is to indicate the second wireless communication device is facedown.

Example 42 includes the subject matter of any one of Examples 36-41, and optionally, comprising an output unit, wherein the controller is to instruct the output unit to output the recommendation.

Example 43 includes the subject matter of any one of Examples 36-42, and optionally, comprising a display, wherein the controller is to instruct the display to display the recommendation.

Example 44 includes the subject matter of any one of Examples 36-43, and optionally, wherein the radio is to send to the second wireless communication device a message including the recommendation to change the orientation of the second wireless communication device.

Example 45 includes the subject matter of any one of Examples 36-44, and optionally, wherein the orientation feedback includes one or more orientation measurements of the second wireless communication device.

Example 46 includes the subject matter of any one of Examples 36-45, and optionally, wherein the orientation feedback includes a compass direction of the second wireless communication device.

Example 47 includes the subject matter of any one of Examples 36-46, and optionally, wherein the orientation feedback includes an accelerometer measurement of the second wireless communication device.

Example 48 includes the subject matter of any one of Examples 36-47, and optionally, wherein the directional wireless communication link comprises a Directional Multi-Gigabit (DMG) link.

Example 49 includes the subject matter of any one of Examples 36-48, and optionally, comprising a docking station.

Example 50 includes the subject matter of any one of Examples 36-48, and optionally, comprising a mobile device.

Example 51 includes a first wireless communication device comprising at least one antenna; a memory; a processor; a radio to establish a directional wireless communication link with a second wireless communication device; and a controller to send an orientation request to the second wireless communication device, subsequent to establishment of the directional wireless communication link, the controller to receive an orientation feedback from the second wireless communication device in response to the orientation request, the orientation feedback including an indication of an estimated orientation of the second wireless communication device.

Example 52 includes the subject matter of Example 51, and optionally, wherein, based on the estimated orientation of the second wireless communication device, the controller is to output a recommendation to change an orientation of the second wireless communication device.

Example 53 includes the subject matter of Example 52, and optionally, wherein the controller is to determine a relative directionality between the first and second wireless communication devices based on the orientation feedback, and wherein the controller is to output the recommendation based on the relative directionality.

Example 54 includes the subject matter of Example 51 or 52, and optionally, wherein the orientation feedback comprises a compass direction of the second wireless communication device, and wherein the controller is to output the recommendation based on the compass direction of the second wireless communication device and a compass direction of the first wireless communication device.

Example 55 includes the subject matter of Example 51 or 52, and optionally, wherein the controller is to instruct the first wireless communication device to output a recommendation to invert the second wireless communication device, when the orientation feedback is to indicate the second wireless communication device is facedown.

Example 56 includes the subject matter of any one of Examples 51-55, and optionally, comprising an output unit, wherein the controller is to instruct the output unit to output the recommendation.

Example 57 includes the subject matter of any one of Examples 51-56, and optionally, comprising a display, wherein the controller is to instruct the display to display the recommendation.

Example 58 includes the subject matter of any one of Examples 51-57, and optionally, wherein the radio is to send to the second wireless communication device a message including the recommendation to change the orientation of the second wireless communication device.

Example 59 includes the subject matter of any one of Examples 50-58, and optionally, wherein the radio is to send the orientation request when a quality of the directional wireless communication link is below a quality threshold.

Example 60 includes the subject matter of any one of Examples 50-59, and optionally, wherein the orientation feedback includes one or more orientation measurements of the second wireless communication device.

Example 61 includes the subject matter of any one of Examples 50-60, and optionally, wherein the orientation feedback includes a compass direction of the second wireless communication device.

Example 62 includes the subject matter of any one of Examples 50-61, and optionally, wherein the orientation feedback includes an accelerometer measurement of the second wireless communication device.

Example 63 includes the subject matter of any one of Examples 50-62, and optionally, wherein the directional wireless communication link comprises a Directional Multi-Gigabit (DMG) link.

Example 64 includes the subject matter of any one of Examples 50-63, and optionally, comprising a docking station.

Example 65 includes the subject matter of any one of Examples 50-63, and optionally, comprising a mobile device.

Example 66 includes a first wireless communication device comprising at least one antenna; a memory; a processor; a radio to establish a directional wireless communication link with a second wireless communication device; and a controller to receive from the second wireless communication device an orientation request subsequent to establishment of the directional wireless communication link, and to send to the second wireless communication device an orientation feedback in response to the orientation request, the orientation feedback including an indication of an estimated orientation of the first wireless communication device.

Example 67 includes the subject matter of Example 66, and optionally, wherein the controller is to receive the orientation request when a quality of the directional wireless communication link is below a quality threshold.

Example 68 includes the subject matter of Example 66 or 67, and optionally, wherein the orientation feedback comprises a compass direction of the first wireless communication device.

Example 69 includes the subject matter of any one of Examples 66-68, and optionally, wherein the orientation feedback is to indicate whether or not the first wireless communication device is facedown.

Example 70 includes the subject matter of any one of Examples 66-69, and optionally, wherein the orientation feedback includes one or more orientation measurements of the first wireless communication device.

Example 71 includes the subject matter of any one of Examples 66-70, and optionally, wherein the orientation feedback includes an accelerometer measurement of the first wireless communication device.

Example 72 includes the subject matter of any one of Examples 66-71, and optionally, comprising an output unit, wherein the controller is to receive from the second wireless communication device a message including a recommendation to change the orientation of the first wireless communication device, and wherein the controller is to instruct the output unit to output the recommendation.

Example 73 includes the subject matter of any one of Examples 66-72, and optionally, comprising a display, wherein the controller is to receive from the second wireless communication device a message including a recommendation to change the orientation of the first wireless communication device, and wherein the controller is to instruct the display to display the recommendation.

Example 74 includes the subject matter of any one of Examples 66-73, and optionally, wherein the directional wireless communication link comprises a Directional Multi-Gigabit (DMG) link.

Example 75 includes the subject matter of any one of Examples 66-74, and optionally, comprising a mobile device.

Example 76 includes a method performed by a first wireless communication device, the method comprising establishing a directional wireless communication link with a second wireless communication device; receiving from the second wireless communication device an orientation feedback including an indication of an estimated orientation of the second wireless communication device; and based on the estimated orientation of the second wireless communication device, outputting a recommendation to change an orientation of the second wireless communication device.

Example 77 includes the subject matter of Example 76, and optionally, comprising sending to the second wireless communication device a request to send the orientation feedback.

Example 78 includes the subject matter of Example 77, and optionally, comprising sending the request when a quality of the directional wireless communication link is below a quality threshold.

Example 79 includes the subject matter of any one of Examples 76-78, and optionally, comprising determining a relative directionality between the first and second wireless communication devices based on the orientation feedback, and outputting the recommendation based on the relative directionality.

Example 80 includes the subject matter of any one of Examples 76-79, and optionally, wherein the orientation feedback comprises a compass direction of the second wireless communication device, the method comprising outputting the recommendation based on the compass direction of the second wireless communication device and a compass direction of the first wireless communication device.

Example 81 includes the subject matter of any one of Examples 76-79, and optionally, comprising instructing the first wireless device to output a recommendation to invert the second wireless communication device, when the orientation feedback is to indicate the second wireless communication device is facedown.

Example 82 includes the subject matter of any one of Examples 76-81, and optionally, comprising instructing an output unit of the first wireless communication device to output the recommendation.

Example 83 includes the subject matter of any one of Examples 76-82, and optionally, comprising instructing a display of the first wireless communication device to display the recommendation.

Example 84 includes the subject matter of any one of Examples 76-83, and optionally, comprising sending to the second wireless communication device a message including the recommendation to change the orientation of the second wireless communication device.

Example 85 includes the subject matter of any one of Examples 76-84, and optionally, wherein the orientation feedback includes one or more orientation measurements of the second wireless communication device.

Example 86 includes the subject matter of any one of Examples 76-85, and optionally, wherein the orientation feedback includes a compass direction of the second wireless communication device.

Example 87 includes the subject matter of any one of Examples 76-86, and optionally, wherein the orientation feedback includes an accelerometer measurement of the second wireless communication device.

Example 88 includes the subject matter of any one of Examples 76-87, and optionally, wherein the directional wireless communication link comprises a Directional Multi-Gigabit (DMG) link.

Example 89 includes a method performed by a first wireless communication device, the method comprising establishing a directional wireless communication link with a second wireless communication device; transmitting to the second wireless communication device an orientation request; and receiving from the second wireless communication device an orientation feedback in response to the orientation request, the orientation feedback including an indication of an estimated orientation of the second wireless communication device.

Example 90 includes the subject matter of Example 89, and optionally, comprising outputting a recommendation to change an orientation of the second wireless communication device, based on the estimated orientation of the second wireless communication device.

Example 91 includes the subject matter of Example 90, and optionally, comprising determining a relative directionality between the first and second wireless communication devices based on the orientation feedback, and outputting the recommendation based on the relative directionality.

Example 92 includes the subject matter of Example 90 or 91, and optionally, wherein the orientation feedback comprises a compass direction of the second wireless communication device, the method comprising outputting the recommendation based on the compass direction of the second wireless communication device and a compass direction of the first wireless communication device.

Example 93 includes the subject matter of Example 90 or 91, and optionally, comprising instructing the first wireless communication device to output a recommendation to invert the second wireless communication device, when the orientation feedback is to indicate the second wireless communication device is facedown.

Example 94 includes the subject matter of any one of Examples 90-93, and optionally, comprising instructing an output unit of the first wireless communication device to output the recommendation.

Example 95 includes the subject matter of any one of Examples 90-94, and optionally, comprising instructing a display of the first wireless communication device to display the recommendation.

Example 96 includes the subject matter of any one of Examples 90-95, and optionally, comprising sending to the second wireless communication device a message including the recommendation to change the orientation of the second wireless communication device.

Example 97 includes the subject matter of any one of Examples 89-96, and optionally, comprising sending the orientation request when a quality of the directional wireless communication link is below a quality threshold.

Example 98 includes the subject matter of any one of Examples 89-97, and optionally, wherein the orientation feedback includes one or more orientation measurements of the second wireless communication device.

Example 99 includes the subject matter of any one of Examples 89-98, and optionally, wherein the orientation feedback includes a compass direction of the second wireless communication device.

Example 100 includes the subject matter of any one of Examples 89-99, and optionally, wherein the orientation feedback includes an accelerometer measurement of the second wireless communication device.

Example 101 includes the subject matter of any one of Examples 89-100, and optionally, wherein the directional wireless communication link comprises a Directional Multi-Gigabit (DMG) link.

Example 102 includes a method performed by a first wireless communication device, the method comprising establishing a directional wireless communication link with a second wireless communication device; receiving from the second wireless communication device an orientation request; and transmitting to the second wireless communication device an orientation feedback in response to the orientation request, the orientation feedback including an indication of an estimated orientation of the first wireless communication device.

Example 103 includes the subject matter of Example 102, and optionally, comprising receiving the orientation request when a quality of the directional wireless communication link is below a quality threshold.

Example 104 includes the subject matter of Example 102 or 103, and optionally, wherein the orientation feedback comprises a compass direction of the first wireless communication device.

Example 105 includes the subject matter of any one of Examples 102-104, and optionally, wherein the orientation feedback is to indicate whether or not the first wireless communication device is facedown.

Example 106 includes the subject matter of any one of Examples 102-105, and optionally, wherein the orientation feedback includes one or more orientation measurements of the first wireless communication device.

Example 107 includes the subject matter of any one of Examples 102-106, and optionally, wherein the orientation feedback includes an accelerometer measurement of the first wireless communication device.

Example 108 includes the subject matter of any one of Examples 102-107, and optionally, comprising receiving from the second wireless communication device a message including a recommendation to change the orientation of the first wireless communication device, and instructing an output unit of the first wireless communication device to output the recommendation.

Example 109 includes the subject matter of any one of Examples 102-108, and optionally, comprising receiving from the second wireless communication device a message including a recommendation to change the orientation of the first wireless communication device, and instructing a display of the first wireless communication device to display the recommendation.

Example 110 includes the subject matter of any one of Examples 102-109, and optionally, wherein the directional wireless communication link comprises a Directional Multi-Gigabit (DMG) link.

Example 111 includes a product including one or more tangible computer-readable non-transitory storage media comprising computer-executable instructions operable to, when executed by at least one computer processor, enable the at least one computer processor to implement a method comprising at a first wireless communication device, establishing a directional wireless communication link with a second wireless communication device; receiving from the second wireless communication device an orientation feedback including an indication of an estimated orientation of the second wireless communication device; and based on the estimated orientation of the second wireless communication device, outputting a recommendation to change an orientation of the second wireless communication device.

Example 112 includes the subject matter of Example 111, and optionally, wherein the method comprises sending to the second wireless communication device a request to send the orientation feedback.

Example 113 includes the subject matter of Example 112, and optionally, wherein the method comprises sending the request when a quality of the directional wireless communication link is below a quality threshold.

Example 114 includes the subject matter of any one of Examples 111-113, and optionally, wherein the method comprises determining a relative directionality between the first and second wireless communication devices based on the orientation feedback, and outputting the recommendation based on the relative directionality.

Example 115 includes the subject matter of any one of Examples 111-114, and optionally, wherein the orientation feedback comprises a compass direction of the second wireless communication device, and wherein the method comprises outputting the recommendation based on the compass direction of the second wireless communication device and a compass direction of the first wireless communication device.

Example 116 includes the subject matter of any one of Examples 111-114, and optionally, wherein the method comprises instructing the first wireless device to output a recommendation to invert the second wireless communication device, when the orientation feedback is to indicate the second wireless communication device is facedown.

Example 117 includes the subject matter of any one of Examples 111-116, and optionally, wherein the method comprises instructing an output unit of the first wireless communication device to output the recommendation.

Example 118 includes the subject matter of any one of Examples 111-117, and optionally, wherein the method comprises instructing a display of the first wireless communication device to display the recommendation.

Example 119 includes the subject matter of any one of Examples 111-118, and optionally, wherein the method comprises sending to the second wireless communication device a message including the recommendation to change the orientation of the second wireless communication device.

Example 120 includes the subject matter of any one of Examples 111-119, and optionally, wherein the orientation feedback includes one or more orientation measurements of the second wireless communication device.

Example 121 includes the subject matter of any one of Examples 111-120, and optionally, wherein the orientation feedback includes a compass direction of the second wireless communication device.

Example 122 includes the subject matter of any one of Examples 111-121, and optionally, wherein the orientation feedback includes an accelerometer measurement of the second wireless communication device.

Example 123 includes the subject matter of any one of Examples 111-122, and optionally, wherein the directional wireless communication link comprises a Directional Multi-Gigabit (DMG) link.

Example 124 includes a product including one or more tangible computer-readable non-transitory storage media comprising computer-executable instructions operable to, when executed by at least one computer processor, enable the at least one computer processor to implement a method comprising at a first wireless communication device, establishing a directional wireless communication link with a second wireless communication device; transmitting to the second wireless communication device an orientation request; and receiving from the second wireless communication device an orientation feedback in response to the orientation request, the orientation feedback including an indication of an estimated orientation of the second wireless communication device.

Example 125 includes the subject matter of Example 124, and optionally, wherein the method comprises outputting a recommendation to change an orientation of the second wireless communication device, based on the estimated orientation of the second wireless communication device.

Example 126 includes the subject matter of Example 125, and optionally, wherein the method comprises determining a relative directionality between the first and second wireless communication devices based on the orientation feedback, and outputting the recommendation based on the relative directionality.

Example 127 includes the subject matter of Example 125 or 126, and optionally, wherein the orientation feedback comprises a compass direction of the second wireless communication device, and wherein the method comprises outputting the recommendation based on the compass direction of the second wireless communication device and a compass direction of the first wireless communication device.

Example 128 includes the subject matter of Example 125 or 126, and optionally, wherein the method comprises instructing the first wireless communication device to output a recommendation to invert the second wireless communication device, when the orientation feedback is to indicate the second wireless communication device is facedown.

Example 129 includes the subject matter of any one of Examples 125-128, and optionally, wherein the method comprises instructing an output unit of the first wireless communication device to output the recommendation.

Example 130 includes the subject matter of any one of Examples 125-129, and optionally, wherein the method comprises instructing a display of the first wireless communication device to display the recommendation.

Example 131 includes the subject matter of any one of Examples 125-130, and optionally, wherein the method comprises sending to the second wireless communication device a message including the recommendation to change the orientation of the second wireless communication device.

Example 132 includes the subject matter of any one of Examples 124-131, and optionally, wherein the method comprises sending the orientation request when a quality of the directional wireless communication link is below a quality threshold.

Example 133 includes the subject matter of any one of Examples 124-132, and optionally, wherein the orientation feedback includes one or more orientation measurements of the second wireless communication device.

Example 134 includes the subject matter of any one of Examples 124-133, and optionally, wherein the orientation feedback includes a compass direction of the second wireless communication device.

Example 135 includes the subject matter of any one of Examples 124-134, and optionally, wherein the orientation feedback includes an accelerometer measurement of the second wireless communication device.

Example 136 includes the subject matter of any one of Examples 124-135, and optionally, wherein the directional wireless communication link comprises a Directional Multi-Gigabit (DMG) link.

Example 137 includes a product including one or more tangible computer-readable non-transitory storage media comprising computer-executable instructions operable to, when executed by at least one computer processor, enable the at least one computer processor to implement a method comprising at a first wireless communication device, establishing a directional wireless communication link with a second wireless communication device; receiving from the second wireless communication device an orientation request; and transmitting to the second wireless communication device an orientation feedback in response to the orientation request, the orientation feedback including an indication of an estimated orientation of the first wireless communication device.

Example 138 includes the subject matter of Example 137, and optionally, wherein the method comprises receiving the orientation request when a quality of the directional wireless communication link is below a quality threshold.

Example 139 includes the subject matter of Example 137 or 138, and optionally, wherein the orientation feedback comprises a compass direction of the first wireless communication device.

Example 140 includes the subject matter of any one of Examples 137-1139, and optionally, wherein the orientation feedback is to indicate whether or not the first wireless communication device is facedown.

Example 141 includes the subject matter of any one of Examples 137-141, and optionally, wherein the orientation feedback includes one or more orientation measurements of the first wireless communication device.

Example 142 includes the subject matter of any one of Examples 137-141, and optionally, wherein the orientation feedback includes a compass direction of the first wireless communication device.

Example 143 includes the subject matter of any one of Examples 137-142, and optionally, wherein the orientation feedback includes an accelerometer measurement of the first wireless communication device.

Example 144 includes the subject matter of any one of Examples 137-143, and optionally, wherein the method comprises receiving from the second wireless communication device a message including a recommendation to change the orientation of the first wireless communication device, and instructing an output unit of the first wireless communication device to output the recommendation.

Example 145 includes the subject matter of any one of Examples 137-144, and optionally, wherein the method comprises receiving from the second wireless communication device a message including a recommendation to change the orientation of the first wireless communication device, and instructing a display of the first wireless communication device to display the recommendation.

Example 146 includes the subject matter of any one of Examples 137-145, and optionally, wherein the directional wireless communication link comprises a Directional Multi-Gigabit (DMG) link.

Example 147 includes an apparatus comprising means for establishing, at a first wireless communication device, a directional wireless communication link with a second wireless communication device; means for receiving from the second wireless communication device an orientation feedback including an indication of an estimated orientation of the second wireless communication device; and means for, based on the estimated orientation of the second wireless communication device, outputting a recommendation to change an orientation of the second wireless communication device.

Example 148 includes the subject matter of Example 147, and optionally, comprising means for sending to the second wireless communication device a request to send the orientation feedback.

Example 149 includes the subject matter of Example 148, and optionally, comprising means for sending the request when a quality of the directional wireless communication link is below a quality threshold.

Example 150 includes the subject matter of any one of Examples 147-149, and optionally, comprising means for determining a relative directionality between the first and second wireless communication devices based on the orientation feedback, and means for outputting the recommendation based on the relative directionality.

Example 151 includes the subject matter of any one of Examples 147-150, and optionally, wherein the orientation feedback comprises a compass direction of the second wireless communication device, the apparatus comprising means for outputting the recommendation based on the compass direction of the second wireless communication device and a compass direction of the first wireless communication device.

Example 152 includes the subject matter of any one of Examples 147-150, and optionally, comprising means for instructing the first wireless device to output a recommendation to invert the second wireless communication device, when the orientation feedback is to indicate the second wireless communication device is facedown.

Example 153 includes the subject matter of any one of Examples 147-152, and optionally, comprising means for instructing an output unit of the first wireless communication device to output the recommendation.

Example 154 includes the subject matter of any one of Examples 147-153, and optionally, comprising means for instructing a display of the first wireless communication device to display the recommendation.

Example 155 includes the subject matter of any one of Examples 147-154, and optionally, comprising means for sending to the second wireless communication device a message including the recommendation to change the orientation of the second wireless communication device.

Example 156 includes the subject matter of any one of Examples 147-155, and optionally, wherein the orientation feedback includes one or more orientation measurements of the second wireless communication device.

Example 157 includes the subject matter of any one of Examples 147-156, and optionally, wherein the orientation feedback includes a compass direction of the second wireless communication device.

Example 158 includes the subject matter of any one of Examples 147-157, and optionally, wherein the orientation feedback includes an accelerometer measurement of the second wireless communication device.

Example 159 includes the subject matter of any one of Examples 147-158, and optionally, wherein the directional wireless communication link comprises a Directional Multi-Gigabit (DMG) link.

Example 160 includes an apparatus comprising means for establishing, at a first wireless communication device, a directional wireless communication link with a second wireless communication device; means for transmitting to the second wireless communication device an orientation request; and means for receiving from the second wireless communication device an orientation feedback in response to the orientation request, the orientation feedback including an indication of an estimated orientation of the second wireless communication device.

Example 161 includes the subject matter of Example 160, and optionally, comprising means for, based on the estimated orientation of the second wireless communication device, outputting a recommendation to change an orientation of the second wireless communication device.

Example 162 includes the subject matter of Example 161, and optionally, comprising means for determining a relative directionality between the first and second wireless communication devices based on the orientation feedback, and means for outputting the recommendation based on the relative directionality.

Example 163 includes the subject matter of Example 161 or 162, and optionally, wherein the orientation feedback comprises a compass direction of the second wireless communication device, the apparatus comprising means for outputting the recommendation based on the compass direction of the second wireless communication device and a compass direction of the first wireless communication device.

Example 164 includes the subject matter of Example 161 or 162, and optionally, comprising means for instructing the first wireless communication device to output a recommendation to invert the second wireless communication device, when the orientation feedback is to indicate the second wireless communication device is facedown.

Example 165 includes the subject matter of any one of Examples 161-164, and optionally, comprising means for instructing an output unit of the first wireless communication device to output the recommendation.

Example 166 includes the subject matter of any one of Examples 161-165, and optionally, comprising means for instructing a display of the first wireless communication device to display the recommendation.

Example 167 includes the subject matter of any one of Examples 161-166, and optionally, comprising means for sending to the second wireless communication device a message including the recommendation to change the orientation of the second wireless communication device.

Example 168 includes the subject matter of any one of Examples 160-167, and optionally, comprising means for sending the orientation request when a quality of the directional wireless communication link is below a quality threshold.

Example 169 includes the subject matter of any one of Examples 160-168, and optionally, wherein the orientation feedback includes one or more orientation measurements of the second wireless communication device.

Example 170 includes the subject matter of any one of Examples 160-169, and optionally, wherein the orientation feedback includes a compass direction of the second wireless communication device.

Example 171 includes the subject matter of any one of Examples 160-170, and optionally, wherein the orientation feedback includes an accelerometer measurement of the second wireless communication device.

Example 172 includes the subject matter of any one of Examples 160-171, and optionally, wherein the directional wireless communication link comprises a Directional Multi-Gigabit (DMG) link.

Example 173 includes an apparatus comprising means for establishing, at a first wireless communication device, a directional wireless communication link with a second wireless communication device; means for receiving from the second wireless communication device an orientation request; and means for transmitting to the second wireless communication device an orientation feedback in response to the orientation request, the orientation feedback including an indication of an estimated orientation of the first wireless communication device.

Example 174 includes the subject matter of Example 173, and optionally, comprising means for receiving the orientation request when a quality of the directional wireless communication link is below a quality threshold.

Example 175 includes the subject matter of Example 173 or 174, and optionally, wherein the orientation feedback comprises a compass direction of the first wireless communication device.

Example 176 includes the subject matter of any one of Examples 173-175, and optionally, wherein the orientation feedback is to indicate whether or not the first wireless communication device is facedown.

Example 177 includes the subject matter of any one of Examples 173-176, and optionally, wherein the orientation feedback includes one or more orientation measurements of the first wireless communication device.

Example 178 includes the subject matter of any one of Examples 173-177, and optionally, wherein the orientation feedback includes an accelerometer measurement of the first wireless communication device.

Example 179 includes the subject matter of any one of Examples 173-178, and optionally, comprising means for receiving from the second wireless communication device a message including a recommendation to change the orientation of the first wireless communication device, and instructing an output unit of the first wireless communication device to output the recommendation.

Example 180 includes the subject matter of any one of Examples 173-179, and optionally, comprising means for receiving from the second wireless communication device a message including a recommendation to change the orientation of the first wireless communication device, and instructing a display of the first wireless communication device to display the recommendation.

Example 181 includes the subject matter of any one of Examples 173-180, and optionally, wherein the directional wireless communication link comprises a Directional Multi-Gigabit (DMG) link.

Functions, operations, components and/or features described herein with reference to one or more embodiments, may be combined with, or may be utilized in combination with, one or more other functions, operations, components and/or features described herein with reference to one or more other embodiments, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. An apparatus comprising:
a radio to receive at a first wireless communication device an orientation feedback from a second wireless communication device, subsequent to establishment of a directional wireless communication link with said second wireless communication device, the orientation feedback including an indication of an estimated orientation of said second wireless communication device; and
a controller to output a recommendation to change an orientation of said second wireless communication device, based on the estimated orientation of said second wireless communication device.

2. The apparatus of claim 1, wherein said radio is to send to said second wireless communication device a request to send said orientation feedback.

3. The apparatus of claim 2, wherein said radio is to send said request when a quality of said directional wireless communication link is below a quality threshold.

4. The apparatus of claim 1, wherein said controller is to determine a relative directionality between said first and second wireless communication devices based on said orientation feedback, and wherein said controller is to output said recommendation based on said relative directionality.

5. The apparatus of claim 1, wherein said orientation feedback comprises a compass direction of said second wireless communication device, and wherein said controller is to output said recommendation based on the compass direction of said second wireless communication device and a compass direction of said first wireless communication device.

6. The apparatus of claim 1, wherein said controller is to instruct said first wireless device to output a recommendation to invert said second wireless communication device, when said orientation feedback is to indicate said second wireless communication device is facedown.

7. The apparatus of claim 1, wherein said controller is to instruct an output unit of said first wireless communication device to output said recommendation.

8. The apparatus of claim 1, wherein said radio is to send to said second wireless communication device a message including the recommendation to change the orientation of said second wireless communication device.

9. The apparatus of claim 1, wherein said orientation feedback includes one or more orientation measurements of said second wireless communication device.

10. The apparatus of claim 1, wherein said orientation feedback includes a compass direction of said second wireless communication device or an accelerometer measurement of said second wireless communication device.

11. The apparatus of claim 1, wherein said directional wireless communication link comprises a Directional Multi-Gigabit (DMG) link.

12. A system comprising a first wireless communication device, the first wireless communication device including:
one or more antennas;
a memory;
a processor;
a radio to receive an orientation feedback from a second wireless communication device, subsequent to establishment of a directional wireless communication link with said second wireless communication device, the orientation feedback including an indication of an estimated orientation of said second wireless communication device; and
a controller to output a recommendation to change an orientation of said second wireless communication device, based on the estimated orientation of said second wireless communication device.

13. The system of claim 12, further comprising a display, wherein said controller is to instruct the display to display said recommendation.

14. The system of claim 12, wherein said controller is to determine a relative directionality between said first and second wireless communication devices based on said orientation feedback, and wherein said controller is to output said recommendation based on said relative directionality.

15. An apparatus comprising:
a radio to establish a directional wireless communication link between a first wireless communication device and a second wireless communication device; and
a controller to receive at said first wireless communication device an orientation request from said second wireless communication device, subsequent to the establishment of said directional wireless communication link, said controller to send to said second wireless communication device an orientation feedback in response to said orientation request, the orientation feedback including an indication of an estimated orientation of said first wireless communication device.

16. The apparatus of claim 15, wherein said orientation feedback comprises a compass direction of said first wireless communication device.

17. The apparatus of claim 15, wherein said controller is to receive from said second wireless communication device a message including a recommendation to change the orientation of said first wireless communication device, and wherein said controller is to instruct an output unit of said first wireless communication device to output said recommendation.

18. A first wireless communication device comprising:
one or more antennas;
a memory;
a processor;
a radio to establish a directional wireless communication link with a second wireless communication device; and
a controller to receive from the second wireless communication device an orientation request subsequent to establishment of said directional wireless communication link, and to send to the second wireless communication device an orientation feedback in response to said orientation request, the orientation feedback including an indication of an estimated orientation of said first wireless communication device.

19. The first wireless communication device of claim 18, wherein said orientation feedback comprises a compass direction of said first wireless communication device or an accelerometer measurement of said first wireless communication device.

20. A product including one or more tangible computer-readable non-transitory storage media comprising computer-executable instructions operable to, when executed by at least one computer processor, enable the at least one computer processor to implement a method comprising:
at a first wireless communication device, establishing a directional wireless communication link with a second wireless communication device;
transmitting to the second wireless communication device an orientation request; and
receiving from the second wireless communication device an orientation feedback in response to said orientation request, the orientation feedback including an indication of an estimated orientation of said second wireless communication device.

21. The product of claim 20, wherein said method comprises outputting a recommendation to change an orientation of said second wireless communication device, based on the estimated orientation of said second wireless communication device.

22. The product of claim 21, wherein said method comprises determining a relative directionality between said first and second wireless communication devices based on said orientation feedback, and outputting said recommendation based on said relative directionality.

23. The product of claim 21, wherein said method comprises instructing said first wireless communication device to output a recommendation to invert said second wireless communication device, when said orientation feedback is to indicate said second wireless communication device is facedown.

24. A product including one or more tangible computer-readable non-transitory storage media comprising computer-executable instructions operable to, when executed by at least one computer processor, enable the at least one computer processor to implement a method comprising:
at a first wireless communication device, establishing a directional wireless communication link with a second wireless communication device;
receiving from the second wireless communication device an orientation request; and
transmitting to the second wireless communication device an orientation feedback in response to said orientation request, the orientation feedback including an indication of an estimated orientation of said first wireless communication device.

25. The product of claim 24, wherein the orientation feedback is to indicate whether or not the first wireless communication device is facedown.
